(19) United States
(12) Patent Application Publication
(10) Pub. No.: US 2005/0015098 A1
(43) Pub. Date: Jan. 20, 2005

(54) Vacuum extraction business method

(76) Inventors: Victor L. Vines, Dallas, TX (US); Robert M. Kennard, Dallas, TX (US); Vince L. George, Dallas, TX (US); Neil C. VanHooydonk, Dallas, TX (US); Darrell L. Vines, Lubbock, TX (US)

Correspondence Address: Steven Trasher, 391 Sandhill Dr., Richardson, TX, 75080, US

(21) Appl. No.: 10/619,272

(22) Filed: Jul. 14, 2003

(51) Int. Cl. A61D 1/10

(52) U.S. Cl. 606/123

(57) ABSTRACT

The invention is a method of monitoring and recording factors that occur during a vacuum-based fetal extraction. In one embodiment, the method includes counting a number of pulls made with a vacuum extraction cup that is attached to a fetal head, counting a number of times the vacuum extraction cup pops off the fetal head, counting an amount of time the vacuum extraction cup is attached to the fetal head, automatically recording a maximum cup pressure detected during the time the vacuum extraction cup is attached to the fetal head, and counting an amount of time a pressure is within a predetermined percentage range of the maximum pressure detected during the time the vacuum extraction cup is attached to the fetal head.

### RELATED APPLICATIONS

The present invention is related to co-pending U.S. patent application Ser. No. 09/727,124, entitled Vacuum Extraction Monitor with Attachment For Hand Pump by Dr. Victor Vines, and co-pending U.S. patent application Ser. No. 09/727,006, entitled Vacuum Extraction Monitor for Electric Pump, by Dr Victor Vines, and co-pending U.S. patent application Ser. No. 09/727,123, entitled Vacuum Extraction Monitoring, by Dr Victor Vines. All of which were filed on Nov. 30, 2000.

### TECHNICAL FIELD

The invention relates to business methods, and more specifically, the invention relates to business methods that reduce liability exposure for physicians that perform vacuum extraction deliveries.

### STATEMENT OF A PROBLEM ADDRESSED BY THIS INVENTION

When operative vaginal deliveries are necessary, there are presently two options—forceps extraction, or vacuum extraction. Vacuum extraction in labor/delivery suites has become a well-accepted and commonly performed form of vaginal delivery because it may be less hazardous to the mother and fetus than forceps extraction. However, there is the potential for harm to the fetus from prolonged suction application to the fetal head. In addition, there are guidelines governing the amount of vacuum pressure that should be applied to the fetal head, as well as guidelines regarding the duration of time that the vacuum pressure is applied to the fetal head during vacuum extraction (these guidelines are printed by the manufacturers of vacuum devices, and are also available in medical literature).

Exemplary effects of vacuum extraction on an infant during delivery include: fetal hypoxia, retinal hemorrhage, chignon, scalp marking and abrasion, cephalhematoma and subcutaneous hematoma, neonatal jaundice, intra-cranial hemorrhage, shoulder dystocia, and subgaleal hemorrhage. Subgaleal hematoma is a particularly dangerous condition. Subgaleal hematoma is formed when bleeding occurs into the potential space beneath the aponeurosis of an infant's scalp. It may be a life threatening condition for a newborn baby, and is often considered the most serious complication associated with the vacuum extraction. One danger associated with subgaleal hematoma arises because the subaponeurotic space stretches over the whole part of the cranial vault of the infant, and a large proportion of the baby's blood volume can accumulate in this space (typically, from damage to the emissary veins). Although subgaleal hematoma may occur after forceps and natural deliveries, incidents of subgaleal hematoma are increased considerably in vacuum extractions since the introduction of the vacuum device pulls the aponeurosis from the cranium and may injure the underlying veins. Furthermore, because hemorrhaging into the subgaleal space may occur slowly, and for several hours following delivery, bleeding into the subgaleal space may be difficult to initially detect.

Accordingly, there are occasions when a fetus does poorly during or after vacuum extraction. Whether or not proper guidelines were followed during the delivery process, sometimes a legal claim is made against a doctor, hospital, nurses, and others associated with the delivery, alleging that the guidelines regarding the use of the vacuum device were not followed. The present invention provides a solution for reducing the value of a claim against those associated with a fetal delivery, and also reduces the likelihood of an erroneous claim being filed against these persons.

Selected Overview of Selected Embodiments

The present invention provides technical advantages as systems, devices, and methods for aiding a person who is assisting with fetal extraction. The invention is a method of monitoring and recording factors that occur during a vacuum-based fetal extraction. In one embodiment, the method includes counting a number of pulls made with a vacuum extraction cup that is attached to a fetal head, counting a number of times the vacuum extraction cup pops off the fetal head, counting an amount of time the vacuum extraction cup is attached to the fetal head, automatically recording a maximum pressure detected during the time the vacuum extraction cup is attached to the fetal head, and counting an amount of time a pressure is within a predetermined percentage range of the maximum pressure detected during the time the vacuum extraction cup is attached to the fetal head.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 provides a block diagram of a vacuum device, illustrating systems incorporated by the invention;

FIG. 2 provides a more detailed block schematic of a vacuum device;

FIG. 3 provides a flowchart of a recording algorithm which illustrates one embodiment of the invention;

FIG. 4 illustrates a block flow diagram of a vacuum device algorithm that implements one embodiment of the invention;

FIG. 5 provides a block diagram of an adapter assembly which provides existing vacuum devices the features of the invention, and is accordingly another embodiment of the invention;

FIG. 6 illustrates a pump attachable device capable of attachment to an electrical pump;

FIG. 7 as a tube attachable device;

FIG. 8 illustrates a pump attachable device configured to attach to a hand pump, such as a KIWI hand pump;

FIG. 9A is a flow chart illustrating a process according to the invention;

FIG. 9B is a block-flow diagram of a business method that monitors various factors encountered during fetal vacuum extraction; and

FIG. 10 is a block diagram of a preferred method of practicing the invention.

### AN EXEMPLARY EMBODIMENT OF A BEST MODE

The invention allows physicians to measure and record the amount of pressure and the duration of pressure applied to a fetus' head during vacuum extraction, it enables improved communication between the nurse and delivering physician thus improving the safety of the vacuum assisted delivery, and the invention lowers litigation costs because a permanent record of vacuum pressures applied during delivery is created. Accordingly, the invention provides systems, devices, and methods for aiding a person who is assisting with fetal extraction. The invention is attachable to a vacuum device, and may incorporate a vacuum device. Furthermore, the pressure inside the vacuum device is monitored and recorded by a recording device.

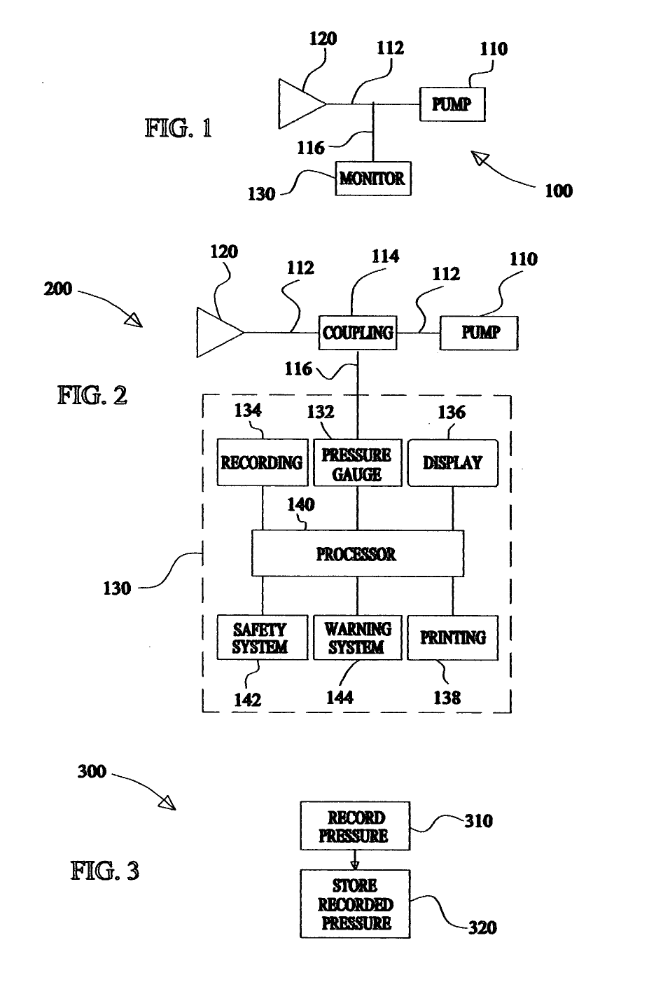

Preferably, the invention provides at least the features of monitoring and recording pressures in a suction device used for vacuum-based fetal extraction. Accordingly, FIG. 1 provides a block diagram of a vacuum device 100, illustrating systems incorporated by the invention. A pump 110 which could be a manually activated hand pump, an electric pump, or any other type of air pump, is fluidly coupled to a suction device 120. The suction device 120 is attachable to a fetus, being preferably attachable to fetal head. The suction device 120 is preferably a cup, such as a SILC, a SILASPIC, a SOFT-CUP, or a MALMSTROM-type cup, for example. Fluid coupling between the suction device 120 and the pump 110 may be accomplished by a tube 112, and is preferably a plastic tube.

A recording device 130, which may be a monitor, an enhanced monitor, or a custom-developed device for example, provides a user the ability to monitor air pressures and record air pressures. Accordingly, air pressures may be measured in the monitor 130, or in the tube 112, or in the pump 110. Furthermore, in FIG. 1, a cable 116 couples the tube 112 to the monitor 130. Accordingly, in this embodiment, an air pressure is detected in the tube 112 and converted into information by a device such as a transducer. Next, the detected pressure is passed as information along the cable 116 to the monitor 130.

With an initial understanding of the vacuum device 100, one may gain a better understanding of the invention by referring to a more detailed block schematic. Accordingly, FIG. 2 provides a more detailed block schematic of a vacuum device 200. The vacuum device 200 has a pump 110 in fluid communication with the suction device 120 through a tubing 112. The tubing 112, although not illustrated, may contain therein a wire for coupling the pump 110 to the suction device 120 (to provide a device which may support traction tension between the pump 110 and the suction device 120). A coupling 114 is shown dividing the tubing 112. However, it should be understood that the coupling 114 need not be intrusive of the tubing 112, and could be embodied as a cap/tap, for example. In any event, the coupling is enabled to detect the pressure in the tubing (whether the pressure is actually detected in the tubing 112, the suction device 120, or the pump 110). Preferably, the coupling 114 is a plastic tube with a transducer therein. Although not shown in FIG. 2, a transducer in the coupling detects a pressure, and then produces a mechanical or electrical signal based on the pressure detected, or other transportable signal based on the detected pressure (such as a wireless radio frequency communication).

The cable 116 provides a commutative connection between the coupling 114 and a pressure gauge 132 located in the recording device 130. Of course, although the pressure gauge 132 is illustrated as being located in the recording device 130, the pressure gauge 132 could in fact be located in the coupling 114, or along the cable 116. Thus, the pressure gauge 132 functions as a mechanical or electrical signal receiver, which translates a mechanical signal, or electrical signal, or a wireless signal into data that is associated with a pressure.

A processor 140 was coupled to the pressure gauge 132, and provides a means for processing data from the pressure gauge 132 and associating that data with various tables, algorithms, and other information. Furthermore, processor 140 may drive other systems such as a display 136, a printing device 138, warning system 144, or a safety system 142, or send information to a recording device 134. Preferably, the processor is a digital signal processor (DSP), a Pentium processor, or a Strong Arm processor, for example. The processor 140 retrieves various tables, algorithms, and other information from the recording device 134, that preferably stores an electronic record. Preferably, the recording device 134 is embodied as memory, such as RAM, ROM, or removable memory such as Flash RAM, a Memory Stick, or a CD ROM.

The display 136 provides real time information, such as pressures over time, dangerous conditions detected (or other information) to persons assisting with the extraction of the fetus. Preferably, the display 136 is a cathode ray video screen, or a plasma screen.

The printing device 138 provides the ability to print numbers or graphs indicating a pressure over time, progressive pressures detected over time. Preferably, the printing device 138 generates these prints on paper. Furthermore, although illustrated as being integrated into the recording device 130, it should be understood that the printing device 138 may be located externally from the recording device 130.

The safety system 142 causes the implementation of a safety pressure release valve preferably located on the pump 110. When triggered, the safety system 142 may release some of the pressure, or all of the pressure thus returning the pressure inside the tubing 112 to the local atmospheric pressure (or room pressure). The safety system 142 may be embodied as software algorithm for execution in memory, or as mechanical device.

The warning system 144 is for producing a warning when a predetermined pressure or pressures are detected. Typically, the predetermined pressure will be a vacuum pressure, which is lower than a predetermined vacuum pressure, such as 0.2 kgms/cm²-0.8 kgms/cm², depending on the stage of delivery. The warning may be embodied as a light, a sound, or a voice, for example. A light may flash at different rates, or present different colors, or present different intensities as pressure changes in the tube. Similarly, a sound may change in tone as different pressures are detected, or a voice may verbally indicate a pressure or a warning condition. Furthermore, the warning system may be used to trigger and provide information to the safety system 142.

A better understanding of the invention may be achieved by examining the operation of the invention. FIG. 3 provides a flowchart of a recording algorithm 300. First, in a record pressure act 310, the recording algorithm 300 records a pressure, which exists in a vacuum device. Then, in a store recorded pressure act 320, the recording algorithm 300 creates a permanent record of the pressure which was recorded in the record pressure act 310.

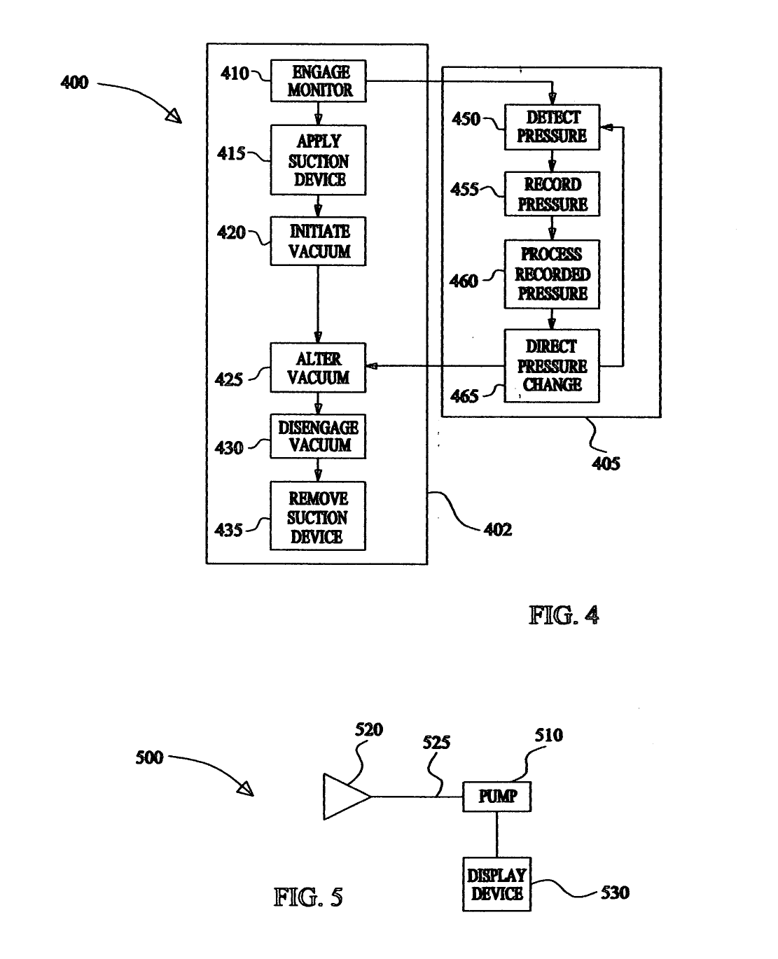

An even better understanding of the invention may be realized by examining the processes flow of a vacuum device embodied according to the invention. Accordingly, FIG. 4 illustrates a block flow diagram of a vacuum device algorithm 400 that implements one embodiment of the invention. The vacuum device algorithm 400 comprises a pump algorithm 402 for illustrating acts performed with a vacuum device pump, and a monitor algorithm 405 illustrating acts associated with a recording device. The vacuum device algorithm 400 begins in a pump algorithm 402.

The pump algorithm 402 is initiated in an engage monitor act 410. The engage monitor act may include attaching a cable between a vacuum pump and a recording device, and then turning on the recording device. After the engage monitor act 410, the pump algorithm 402 proceeds to an apply suction device act 415 in which a suction device is attached to a fetus, and preferably a fetal head. It should be noted that in the apply suction device act 415, if a disposable MITYVAC is being used in the procedure, adapters should be attached to suction tubing of the vacuum device and the disposable MITYVAC assembly. Prior to applying the suction device to the fetus, the apply suction device act 415 calibrates, or zeros, the monitor so that the pressure detected prior to applying a vacuum to the fetus is recognized as being the local atmospheric pressure. Likewise, prior to the application of a vacuum to a fetus, the monitor is initialized, or “zeroed,” to local atmospheric conditions.

Following the apply suction device act 415, the pump algorithm 402 proceeds to an initiate vacuum act 420. In the initiate vacuum act 420 a vacuum pressure is created in the vacuum device by manually actuating a manual pump, or by engaging the vacuum switch or trigger in an electric pump. The next act in the pump algorithm 402 changes the vacuum pressure. This is accomplished in an alter vacuum pressure act 425, and is typically employed as a result of a response received from the monitor algorithm 405. Of course, altering the vacuum pressure may not be necessary during a vacuum extraction procedure, and thus the alter vacuum pressure act 425 should especially be viewed as an optional act for the present embodiment (although the only needed acts are explicitly articulated in the claims).

Next, a disengage vacuum act 430 is performed when the pressure in the vacuum device is returned to at least local atmospheric pressure. Furthermore, the pressure may be raised to a pressure greater than local atmospheric pressure to encourage the suction device to separate from the fetus. Then, the vacuum device algorithm 400 and pump algorithm 402 end together in a remove suction device act 435, in which the suction device is removed from the fetus. Furthermore, in the remove suction device act 435 the recording device may be disengaged, and the record of the pressures detected during the vacuum device algorithm 400 may be stored in a permanent medical record, which may be a physical paper record and/or an electronic record.

The monitor algorithm 405 initiates in a detect pressure act 450, which begins in response to the initialization of the recording device in the engage monitor act 410. In the detect pressure act 450 a pressure in the vacuum device is detected, which will typically be between a room (or atmospheric) pressure and vacuum pressure (meaning a pressure lower than the local atmospheric pressures). Next, the vacuum device algorithm 400 continues to a record pressure act 455. In the record pressure act 455 the pressure detected in the detect pressure act 450 is automatically recorded (or stored), preferably by an electronic means (such as a memory) or by a paper means. Furthermore, the record pressure act 455 may include the displaying of the recorded pressure on a monitor or other display.

The recorded pressures are monitored and processed in a process recorded pressure act 460. The process recorded pressure act 460 evaluates the detected pressure in a warning system, and may direct the displaying or printing of additional information in response to the warning system. [The process-recorded pressure 460 may include a sub-act of displaying the processed information on the display device, such as a monitor.] Likewise, if the process is recorded at 460 determines if the detected pressure exceeds a predetermined pressure, the process recorded pressure act 460 may direct a pressure change, such as a lower pressure, or an immediate return to local atmospheric pressure, in a direct pressure change act 465. The direct pressure change act 465 produces the electrical or mechanical signals needed to implement the alter-vacuum pressure act 425.

The invention provides the ability to accurately measure, record, and trace pressure events that transpire in a vacuum device during vacuum extraction. Accordingly, the invention assist physicians, hospitals, and other delivery personnel in the defense of accusation that proper guidelines were not followed during the vacuum extraction. Furthermore, those who suffer from improper vacuum extraction also have access to a permanent medical record, which should facilitate mediated settlements, and avoid the costs of lengthy discovery and emotionally scaring litigation. Also, because data will be collected with each vacuum extraction, the guidelines for the conduct of a vacuum extraction may be changed and improved to more accurately be able to predict safe guidelines for a vacuum extraction delivery.

It will sometimes be advantageous to provide existing vacuum devices the ability to access the advantages provided by the invention. FIG. 5 provides a block diagram of an adapter assembly 500, which provides existing vacuum devices access to advantages of the invention, and is accordingly another embodiment of the invention. The adapter assembly 500 comprises a pump 510 fluidly coupled to a suction device 520 by a tubing 525. A display device 530 is connected to the pump 510. Preferably, the display device 530 is coupled to the pump 510 via an adapter to the pump 510. Better understanding of the adapter assembly 500 may be achieved by examining specific embodiment.

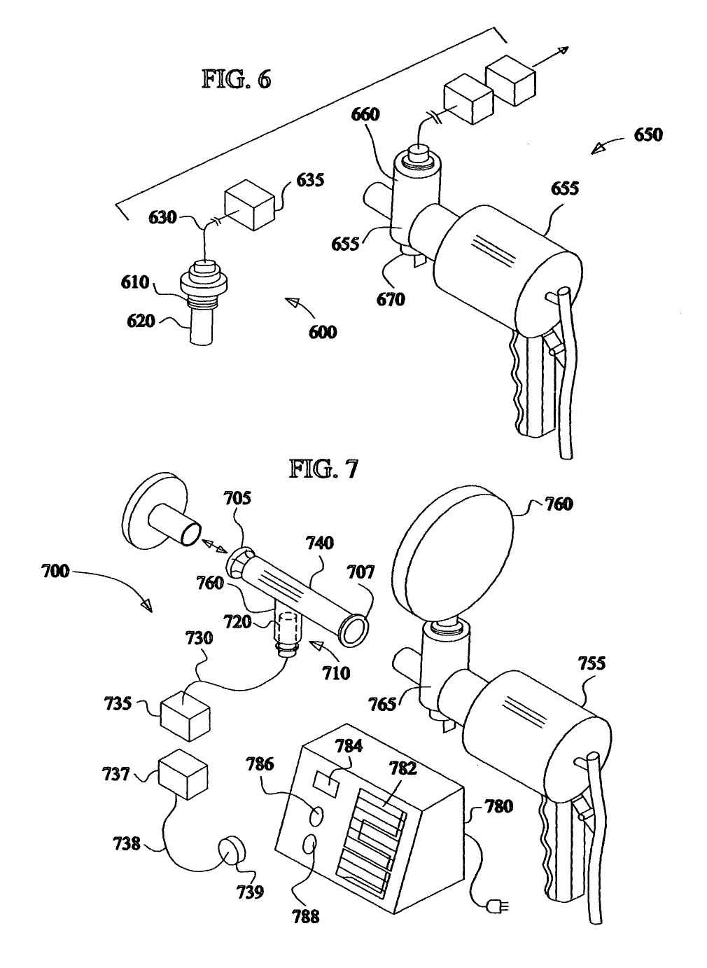

FIG. 6 illustrates a pump attachable device 600 capable of attachment to an electrical pump 655. The pump attachable device 600 has an adapter 610, such as the threaded fittings illustrated in FIG. 6. Furthermore, the pump attachable device 600 has a pressure transducer 620, which detects a pressure and converts the detected pressure to a mechanical or electrical signal capable of being transferred to a monitor (not shown) via a cable 630. The cable 630 includes a plug 635 capable of attachment to a monitor or other recording device.

Also, illustrated in FIG. 6 is a pump system 650 having a pump attachable device attached thereto. The pump system 650 includes an electric pump 655 such as a MITYVAC, or disposable MITYVAC, for example. The electric pump 655 has a front end 665, which has a cavity for supporting other devices and for transporting the pressures, including the vacuum pressure, created by the electric pump 655.

The front end 665 has thereon a pressure gauge receiver 660. Typically, the pressure gauge receiver 660 accepts a pressure gauge that mechanically detects a pressure, which is then displayed for those performing the vacuum procedures. In operation of one embodiment of the invention, the pressure gauge is removed from the electric pump, typically by unscrewing the pressure gauge, and the pump attachable device 600 is then inserted into the pressure gauge receiver 660. Also provided by the front end 665 is a pressure release valve 670. The pressure release valve 670 allows the inflow of air into the front end, and particularly into the cavity of the front end, in order to increase the pressure in the vacuum device.

Another embodiment of the invention is illustrated in FIG. 7 as a tube attachable device 700. The tube attachable device 700 includes a first end 705, and a second end 707. The first end 705 is preferably configured to either attach to a plastic tube section, or a suction device. The second end 707 is preferably configured to attach to a tube, or a front end such as the front end 765 that is adapted to receive the second end 707. The tube attachable device 700 includes tubing 740, which is preferably plastic tubing.

The tubing 740 includes a pressure gauge receiver 760. Accordingly, a transducer/pressure gauge 720 is inserted into the tubing 740 and secured in the tubing by an adapter 710. Furthermore, pressures detected by the pressure transducer 720 are converted into a data signal that is sent to a recording device along a cable 730. The cable 730 also includes a plug 735, which is connectable to the recording device monitor 780, or to a second plug 737. The plug 737 couples an extension cord 738 to a second plug 739. The second plug 739 is also attachable to the recording device 780 at a plug socket 788.

The vacuum device illustrated in FIG. 7 includes a pump 755, which provides a disposable MITYVAC, and a pressure gauge 760, which is fitted into the front end 765. Thus, the vacuum device provides a physician the advantage of having a mechanical visual display provided by the gauge 760 (thus requiring little change by those who are accustom to viewing the mechanical gate 760), as well as providing mechanical and electric displays and printouts of the recorded pressures while the recording device 780.

The recording device 780 may produce a printed-paper record 782, as well as a visual display 784. Of course, the printed-paper record 782 or the visual display 784 may print or display numbers, graphical representation or other indicia of the pressures being detected in the vacuum device. Furthermore, the recording device 780 provides a warning device 786 which could produce a light, sound, or a vocalized recording of a warning to those assisting with the fetal extraction.

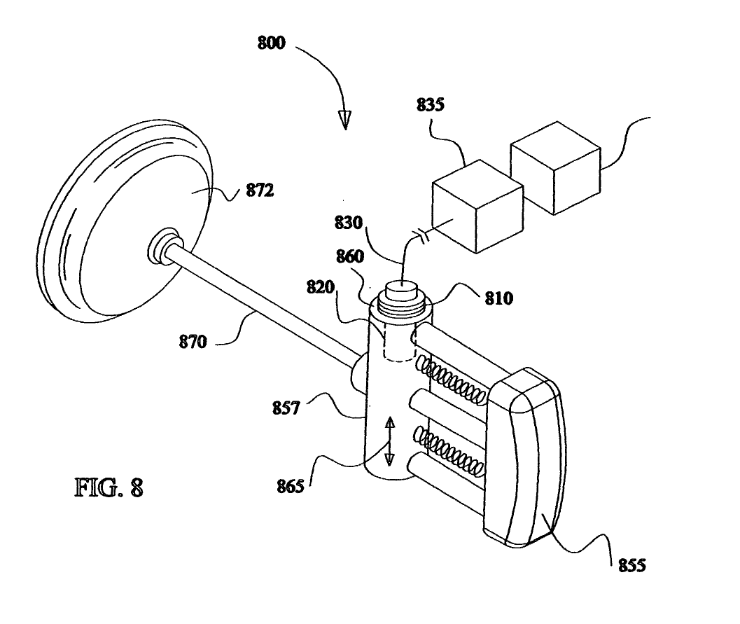

FIG. 8 illustrates a pump attachable device 800 configured to attach to a hand pump 855, such as a KIWI hand pump. The pump attachable device 800 includes an adapter 810, such as threading, gaskets, or other attachments capable of forming a fluid-tight seal, a pressure-recording device 820, such as a transducer, and a cable 830 for communicating a detected pressure to a recording device via a plug 835. The hand pump 855 includes a handle 857, which maintains a vacuum cavity 865 therein. The vacuum cavity 865 is fluidly connected to a hose 870 and a suction device 872. The handle 857 also includes a pressure gauge receiver 860. In an unmodified hand pump, the pressure gauge receive 860 accepts a mechanical pressure gauge that mechanically indicate a detected pressure in the vacuum cavity 865. In the vacuum device according to the present embodiment of the invention, the pump attachable device 800 is secured into the handle 857 of the hand pump 855 via the pressure gauge 860.

Monitoring Vacuum Pressure

Some confusion may be encountered when speaking of a vacuum pressure. A vacuum pressure is generally understood to mean a pressure lower than the local atmospheric pressure, such that when one says the vacuum increases, in reality the difference between the atmospheric pressure and the pressure of the vacuum is increasing while in purely scientific terms the pressure is in fact decreasing.

Thus, a vacuum contrasts with the most common scientific understanding of air pressure, as measured in, for example, centimeters or millimeters of mercury (the mercury system). In the mercury system, 0 mm mercury is an absolute vacuum (this is theoretically impossible), and 76 cm mercury (29.92 inches of mercury) is widely regarded as the “average” atmospheric pressure at sea level. As one goes below sea level, pressure increases (which can lead to pressure implosion). Similarly, as one goes higher into the atmosphere, pressure decreases, indicated by a lower millimeter of mercury value. Pressure, including atmospheric pressure, also varies inversely with temperature.

Accordingly, “increasing the vacuum,” means that a higher vacuum is reached, but a lower absolute pressure is reached, and a “maximum” vacuum pressure is in scientific terms a minimum absolute pressure. However, these differences are understood and appreciated by those of ordinary skill in the mechanical arts, including most physicians.

Preferred Monitoring Methods

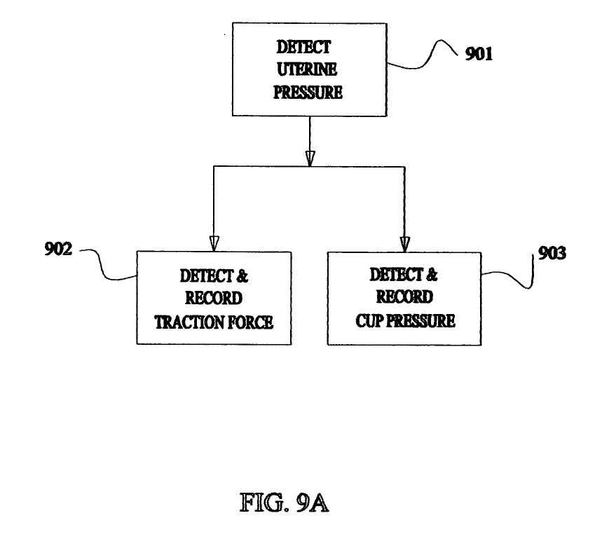

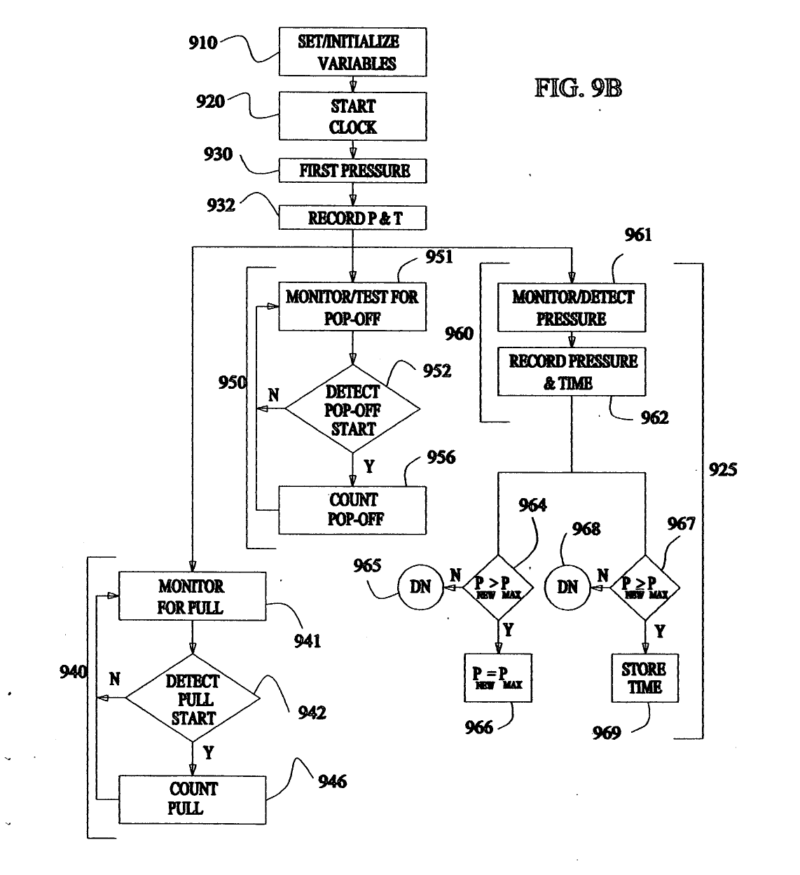

FIGS. 9A and 9B are block-flow diagrams of methods that monitor various vacuum extraction factors. Factors include time, environmental conditions, human or machine generated activities, for example. Factors such as patient consent, fetal condition at the time of birth, and persons present at the delivery further illustrate that factors are broadly characterized as events associated with fetal delivery. By monitoring and recording factors, the value of a claim against a medical professional or another entity involved with a fetal extraction is reduced. Accordingly, the method reduces the risk of frivolous medical malpractice litigation being initiated against medical professionals.

Abbreviated Method

FIG. 9A is a flow chart illustrating a vacuum extraction monitoring process. The vacuum extraction monitoring process begins with a detect uterine pressure act 901. In the detect uterine pressure act 901 a physician uses an Intrauterine Pressure Catheter (IUPC) between the inner surface of a uterus and the fetus to detect the intrauterine pressure (pressure on the IUPC activates a transducer that converts a mechanical displacement into an electric signal). An increased intrauterine pressure indication may reflect a “push,” or contraction of the uterus during labor. The detect uterine pressure act continues to measure uterine pressure until the physician elects to apply the vacuum extraction cup to the fetal head.

At this point, the physician may choose to cease monitoring uterine pressure internally, and may choose to begin monitoring uterine pressure externally. Thus, the detect uterine pressure act 901 may at this point cease. Alternatively, the detect uterine pressure act 901 may continue via the attachment of an External Uterine Monitoring Device (EUMD), also known as a tocodynamometer, to the abdominal region of a patient as is known in the art. Accordingly, by using an EUMD, uterine pressure may be monitored throughout delivery.

Next, the vacuum extraction monitoring process continues with a detect and record traction force 902 act, and a detect and record cup pressure act 903, which preferably execute simultaneously. To detect and record traction force, a tether attached to the vacuum cup pulls on a transducer that converts the tension force of the tether into an electrical signal. Similarly, a cup pressure is detected and recorded via a pressure transducer that is coupled to the vacuum of the vacuum cup. In addition, a single transducer can be coupled to a bridge, such as a Wheatstone bridge, to enable several transducers to communicate simultaneously with a single electric plug-in.

One method of monitoring and recording factors includes the acts illustrated in FIG. 9B. FIG. 9B initiates with a set/initialize variables act 910 in which the electronic system(s) responsible for monitoring fetal delivery reset electric and mechanical sensors to avoid any prejudicing of the system, due to a prior delivery or other factors. Next, in a start clock act 920, the computer clock begins running to enable clock-driven functions. In a preferred embodiment, the clock starts simultaneously with the set/initialize variables act 910.

During vacuum extraction, there are at least two types of pressure that should be detected, monitored and controlled. The first is a uterine pressure (meaning the pressure between a fetus and the uterus), and the second is a cup pressure. Accordingly, in a first pressure act 930 the system detects an intrauterine pressure via an IUPC or EUMD, and then records the detected pressure in a record pressure and time act 932.

After the fetal head has sufficiently exited the uterus and a vacuum extraction cup has been attached to the fetus, additional factors are monitored. For example, in a monitor for pull act 941, the method begins executing a pull detection module 940. The pull detection module 940 automatically counts a number of pulls made with a vacuum extraction cup that is coupled to a fetal head.

A detect pull start query 942 monitors the transceiver coupled to the tether between a pump-grip and a suction cup. If no tension or an insufficient tension is detected (shown by the “N” decision), then the pull module resets to run again. However, if the pull start query 942 detects a pull, then the pull detection module 940 counts the pull by incrementing a counter in a count pull act 946 as the pull detection module 940 executes again, as shown by the “Y” decision.

Preferably, pulling is detected with a pull detector, which is in one embodiment a transceiver. Small tension forces are constantly present in every pull detector device, and thus small tension forces insignificant to the fetus are ignored for purposes of counting a pull. The automated nature of the counting, and other acts, is indicative that the act itself is preferably made without conscious intervention of a person.

One should count the number of times a vacuum device experiences an involuntary detachment of the cup from the fetal head, also known as a “pop-off”. Accordingly, the method automatically counts a number of times the vacuum extraction cup pops off the fetal head with a pop off module 950. The pop off module 950 begins with a monitor for pop off act 951, which preferably executes simultaneously with the pull act 940.

The pop off detection module 950 preferably queries the transducer coupled between a pump-grip and the pump grip's suction cup in a detect pop-off start query 942. Often, one can detect a pop off with a pressure detector that monitors the pressure inside the vacuum cup. When the pressure detector senses a sudden return to ambient pressure, absent the use of a regulator, a pop off is counted. Alternatively, an algorithm that calculates the differential (delta) between measured values can be used. When monitoring differentials, a sudden and sufficiently significant change in slope is indicative of a rapid alteration of vacuum pressure. Absent the use of a regulator, this would also indicate that a pop off is counted.

In one embodiment, the first execution of the pop-off module 950 establishes a baseline cup pressure. Then, in subsequent executions of the pop off module 950, if no sudden change from the prior-measured cup pressure to local atmospheric pressure is detected at a transceiver (shown by the “N” decision), then the pop off module runs again. However, if the pop off module detects a sudden sufficient (preferably predetermined) change in pressure from vacuum to local atmospheric pressure, then the pop off module 950 counts the pop off by incrementing a counter, in a count pop off act 956. The method then returns to the monitor pop off act 951, as shown by the “Y” decision.

The maximum pressure induced in the vacuum cup during birth may influence proper delivery of a live fetus. Sometimes, if a maximum predetermined pressure is exceeded, a subgaleal hematoma may be induced. Similarly, if the maximum pressure is not near a traditional “safe” threshold, then it can be said that any damage to the fetus was likely not caused by the pressure induced in the vacuum cup. Accordingly, it is desired to monitor the pressure detected during the time the vacuum extraction cup is attached to the fetal head, and to record the maximum detected pressure.

A time-pressure module (TP module) 960 detects and monitors pressure over time, beginning with a detect pressure act 961, in which a cup pressure is detected. A record pressure act 962 preferably records both the clock-generated time with the pressure detected in the detect pressure act 960 and stores these values in memory.

The TP module 960 establishes a baseline cup pressure at local atmospheric pressure. Presumably, in subsequent executions of the TP module 960, a higher and higher pressure is detected in a maximum pressure query 964. If the cup pressure is not greater than any prior recorded pressure, the method continues to a Do Nothing (DN) decision block 965, and the “N” decision path. If the cup pressure recorded in the just completed record pressure act 962 is greater than the highest previously recorded pressure, then the method continues to a record new maximum pressure act 966, and the “Y” decision path, where a variable that holds the value of the highest detected cup pressure is changed to the new maximum pressure.

Similarly, the amount of time that a vacuum pressure is exposed to the fetal head should also be recorded. If a vacuum is applied for too much time, a subgaleal hematoma may occur. Thus, in a count vacuum time query 967 the amount of time a vacuum pressure lower than a predetermined vacuum pressure is recorded. In addition, one preferred embodiment records the amount of time the vacuum pressure is within a predetermined percentage range of the maximum vacuum pressure detected. For example, if the maximum pressure detected is 10 psi, and the desired percentage of maximum vacuum pressure to monitor is 10% then the count vacuum time act 950 counts the time at which the vacuum pressure is either 9 or 10 or 11 psi, or the equivalent in another unit of pressure.

Preferably, detected pressures and time are stored together so that there is a correlation between the pressure and time. If the pressure detected is greater than a predetermined pressure, the corresponding pressure, time and temperature data are not stored for purposes of determining total time in a maximum pressure zone, as is illustrated by the Do Nothing (DN) decision block 968, and the ‘N’ decision path. Likewise, if the cup pressure detected the in maximum vacuum pressure query 964 is within some dynamic or predetermined danger zone pressure, the pressure and corresponding time data are stored in a store time act 969.

Although not immediately apparent, during an end act 1270, the time and pressure data is again evaluated and filtered so that the time the fetus is exposed to a statistically significant vacuum pressure is tallied based on some algorithm, such as tallying time where pressure exceeds some dynamic or predetermined danger threshold, or is within a zone of importance.

Although not illustrated, in a count attachment time act the method automatically counts the amount of time the vacuum extraction cup is attached to the fetal head. In one embodiment, an attachment is assumed when the pressure detector detects a pressure a predetermined amount lower than local atmospheric pressure. Then, the method counts the time that the attachment is detected. During deliveries involving more than one attachment (due to pop-offs or releases), the time of each attachment may be monitored separately from the total time of attachment. Thus, the pressure detector and clock may be used together to automatically recording a pressure over a period of time. Sometimes, one may wish to plot pressure on a vertical axis of a graph, and time on the horizontal axis of the graph, thus illustrating a pressure over time line, the approximation of which generates a time-dependent pressure function. It may be desirous to store the time dependent pressure function.

More Detailed Method Embodiment

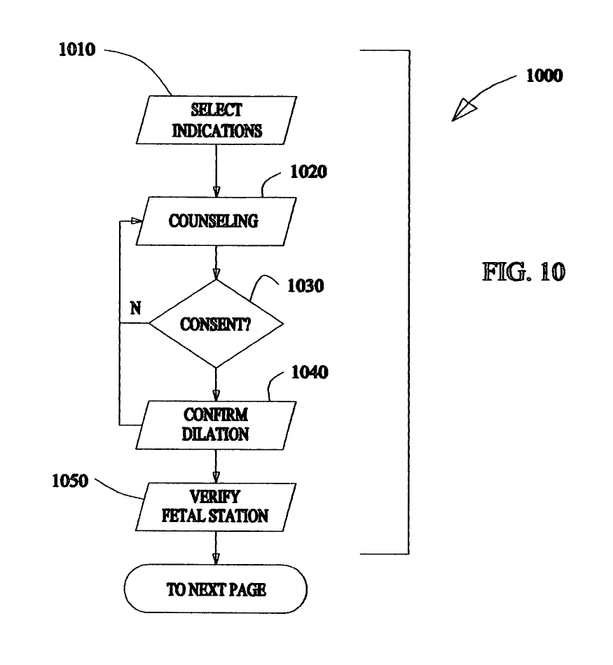

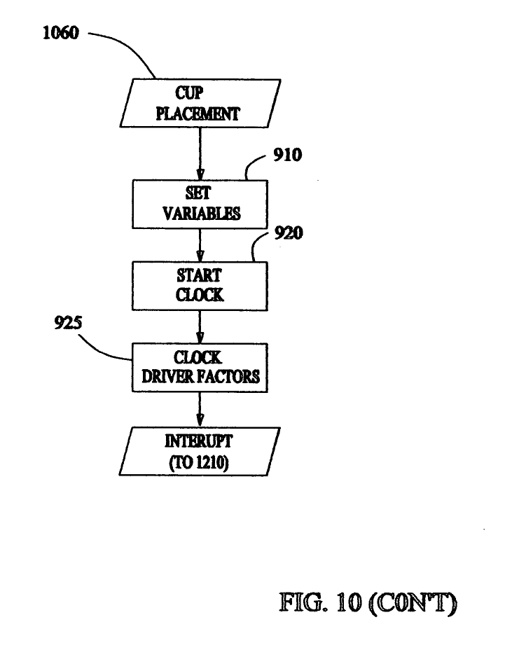

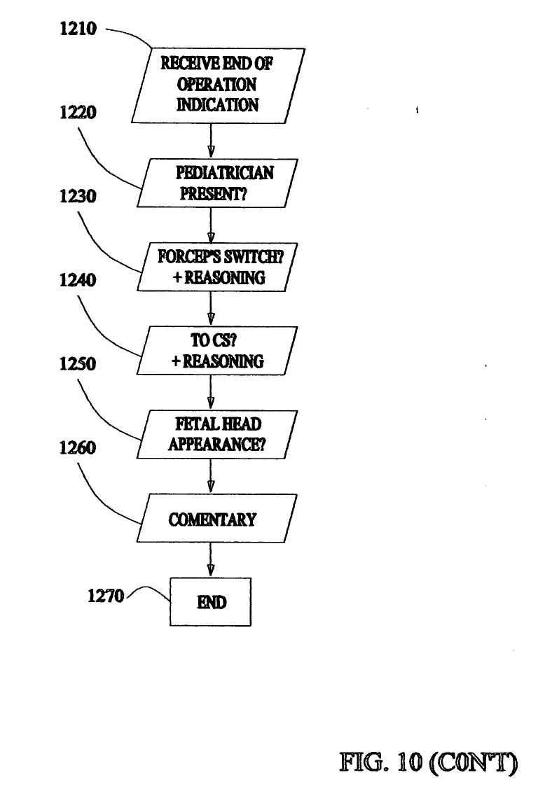

FIG. 10 is a block diagram of a preferred method of practicing the invention.

Pre-Procedure Factors

Pre-procedure factors play an important role in fetal delivery. Accordingly, one may wish to record at least one pre-procedure factor 1000. For example, one may wish to record the reasons for choosing a vacuum extraction over other methods of delivery via a select indications act 1010. These factors may be recorded as check boxes, data entry, or via images, for example. In addition, one may desire a patient-counseling event such as a counseling reminder data entry request (counseling) 1020. Then, recording the patient's consent is provided in a consent query 1030. If no consent is given, the physician typically proceeds to a cesarean section delivery.

Similarly, other queries may request data entry to memorialize a pre-procedure event such as cervical dilation via a confirm dilation query 1040. Likewise, fetal positioning is confirmed via a verify fetal station query 1050, and vacuum cup placement is confirmed via a cup placement query 1060. Accordingly, one may store data evidencing the occurrence of pre-procedure factors, and this data may be used to reduce the likelihood of frivolous litigation. Following a set variables act 910 and a start clock act 920, which have been discussed above, the method proceeds to a clock-driven factors act 925.

Clock-Driven Functions

In the clock driven factors act 925 various factors are monitored and associated with time. However, clock driven factors are not limited to continuous functions such as pressure over time, but include discrete factors such as detecting pop-offs, or special pressure conditions, for example. The monitoring, detection and/or recording of factors preferably continue until an interrupt is received as an end of operation indication 1210.

Outcome Factors

Additional advantages can be obtained by recording at least one outcome factor. After receiving an end of operation indication 1210, one may wish to record the presence of medical personnel in a pediatrician present act 1220. A simple yes/no may record such a presence, or the names and/or pictures may be recorded.

A change from a vacuum pump to a forceps delivery or a cesarean section may be associated with a problematic delivery. Accordingly, one may wish to record a switch from the use of vacuum extraction to the use of another method of birthing. If a physician adopts forceps after beginning with a vacuum delivery, then that physician should record a reason for making the switch in a forceps switch and reasoning act 1230. Similarly, if a physician makes a decision to perform a cesarean section (CS) after beginning with a vacuum delivery, then that physician should record a reason for making the switch in a to CS and reasoning act 1240. Additionally, one may wish to record the appearance of fetal head upon delivery, since the appearance of the fetal head is an indicator of a successful delivery in a fetal head appearance act 1250. Furthermore, additional text, video or audio commentary may be recorded via text or voice in a commentary act 1260 before completing the method in an end act 1270.

Computer Program

The invention may also be exercised as an automated computer program. In one embodiment, a variable is generated for each factor, and then each variable value is changed depending on some detected occurrence. In one embodiment the invention is, in a computer system, a method of monitoring and recording factors that occur during a vacuum-based fetal extraction. The computer program generates a variable for each monitored factor, such as a pull counting variable, a pop-off counting variable, a first attachment duration variable, a maximum pressure variable, a near maximum pressure variable, and a pressure over time variable. Of course, the provided names of the variables are only examples. The specific names of the variables are not limiting, as each variable may be called almost anything. Thus, each variable should be interpreted as being limited only by the function of the variable.

In pre-procedure, post procedure, and during vacuum extraction, each variable may be changed to reflect a change in a monitored variable. For example, the pull counting variable is incremented when a pull is detected. Similarly, the pop-off counting variable is incremented when a pop-off is detected. Non-integer based variables may also be changed, and the word “increment” should not be interpreted as an integer change in value, but rather as any change in value. For example, the first attachment duration variable may be incremented in real time in tenths, hundredths, or even thousandths of seconds. Likewise, some variables are not incremented, but rather changed. For example, the maximum pressure variable is changed when a pressure greater than the existing maximum pressure variable value is detected. Since the maximum detected pressure is not time or event dependent, this value may change haphazardly.

Other variables may be changed to reflect changes in detected factors. For example, the computer program increments the first attachment duration variable in real time when a pressure is within the predetermined range of the maximum pressure variable value. For example, the variable may increment when the pressure is detected within a predetermined range (such as between 80% of the maximum pressure variable to the maximum pressure variable). The computer may also store information regarding when the pressure is in a “safe” range, when the pressure is above a safe range, and when the pressure is below a safe range.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A method of monitoring and recording factors that occur during a vacuum-based fetal extraction, comprising:
automatically counting a number of pulls made with a vacuum extraction cup that is attached to a fetal head;
automatically counting a number of times the vacuum extraction cup pops off the fetal head;
automatically counting an amount of time the vacuum extraction cup is attached to the fetal head;
automatically recording a maximum cup pressure detected during the time the vacuum extraction cup is attached to the fetal head; and
automatically counting an amount of time a cup pressure is within a predetermined percentage range of the maximum pressure detected during the time the vacuum extraction cup is attached to the fetal head.

2. The method of claim 1 wherein a pull detector detects a pull made with a vacuum extraction cup that is attached to a fetal head.

3. The method of claim 1 wherein a pressure detector detects a pop-off of a vacuum extraction cup from a fetal head.

4. The method of claim 1 wherein a pressure detector and a clock are used to count the time the vacuum extraction cup is attached to the fetal head.

5. The method of claim 1 wherein a pressure detector detects, and then records a maximum cup pressure.

6. The method of claim 1 wherein a pressure detector and a clock are used to determine the amount of time a cup pressure is within a predetermined percentage range of the maximum pressure detected during the time the vacuum extraction cup is attached to the fetal head.

7. The method of claim 1 further comprising the act of automatically recording a pressure over a period of time.

8. The method of claim 1 further comprising the act of automatically generating and storing a time-dependent cup pressure function.

9. The method of claim 1 further comprising recording at least one outcome factor.

10. The method of claim 1 further comprising recording an indication of pediatrician presence.

11. The method of claim 1 further comprising recording a forceps switch incident.

12. The method of claim 1 further comprising recording an indication of the appearance of the fetal head upon delivery.

13. The method of claim 12 wherein the appearance is recorded with at least one picture.

14. The method of claim 1 further comprising recording at least one pre-procedure factor.

15. The method of claim 14 wherein the pre-procedure factor comprises at least a counseling reminder.

16. The method of claim 14 wherein the pre-procedure factor comprises at least a consent factor.

17. The method of claim 14 wherein the pre-procedure factor comprises at least an indication of cervical dilation.

18. The method of claim 14 wherein the pre-procedure factor comprises at least a fetal positioning factor.

19. The method of claim 14 wherein the pre-procedure factor comprises at least a placement of cup factor.

20. In a computer system, a method of monitoring and recording factors that occur during a vacuum-based fetal extraction, comprising:
generating a pull counting variable;
generating a pop-off counting variable;
generating a first attachment duration variable;
generating a maximum cup pressure variable;
generating a near maximum cup pressure variable; and
generating a cup pressure over time variable.
